(19) United States
(12) Patent Application Publication
(10) Pub. No.: US 2025/0123806 A1
(43) Pub. Date: Apr. 17, 2025

(54) METHOD AND APPARATUS FOR DETERMINING GEOMETRIC PARAMETERS

(71) Applicant: CodeDog Pty Ltd, Currumbin Queensland (AU)

(72) Inventor: Richard Charles Abercrombie, Currumbin Queensland (AU)

(73) Assignee: CodeDog Pty Ltd, Currumbin Queensland (AU)

(21) Appl. No.: 18/912,299

(22) Filed: Oct. 10, 2024

(30) Foreign Application Priority Data
Oct. 12, 2023 (AU) 2023903265

(51) Int. Cl. G06F 7/548

(52) U.S. Cl. CPC G06F 7/548

(57) ABSTRACT

Disclosed herein an apparatus for determining estimating a measurement for a geometric dimension of an object, wherein the geometric dimension is at an angle to a predetermined reference geometric dimension of the object; comprising a processor, memory storing machine-executable code, and operating system supporting computer processes. The processor is configured to implement the machine-executable code to: receive data indicative of an input angle between the geometric dimension being measured and the reference geometric dimension; determine an integral angle and a fractional angle, respectively being an integral portion and a fractional portion of the input angle; determining trigonometric function values of the fractional angle; obtain determine a first rotation matrix for a first rotation from 0 degrees to the integral angle; determine a second rotation matrix for a second rotation by the fractional angle, based on the trigonometric function values of the fractional angle; determine trigonometric function values of the angle between the geometric dimensions on the basis of a combination of the first and second rotation matrices; estimate the measurement for the geometric dimension based on the trigonometric function values of the input angle and a measurement the predetermined reference geometric dimension.

### TECHNICAL FIELD

This disclosure relates to an apparatus and method for a fast computing to determine geometric dimensions, which may be of three-dimensional object representation models. In particular, it relates to determining trigonometric measurements for the three-dimensional objects or models therefore, to estimate geometric parameters associated with the three-dimensional objects or models.

### BACKGROUND ART

Three-dimensional (3D) models are widely used in object-based processing or visualisation in a vast number of applications, such as 3D graphics processing which is widely used in fields such in 3D-computer games, Computer-Aided Design (CAD), simulations of visual data, financial modelling and data analysis, and the processing of 3D movements for robotics, and navigations systems including flight control and GPS satellites.

In these applications, trigonometric measurements are made so that it is possible to obtain, e.g., a visualization of a 3D model to which a rotation is applied. In some cases, fast computations are needed or desired. For instance in computer gaming or graphics processing it is desirable to have a real time response to the rotation applied to the model. As another example, fast computations of the measurements and parameter estimation is often desirable to be able to help towards a seamless performance of tasks such as components measurements or calibration of instrumentations.

High precision measurements are also required or desired in many applications. For example, there are many industries that measure small angles with sensors or vision systems, such as automotive, aerospace, electronics and robotics to name a few. In many industries a robotics vision system plays a significant role in high-precision angle measurement, calibration of instruments, and quality control.

Existing methods for computing the trigonometric measurements include the CORDIC (Coordinate Rotation Digital Computer) method. CORDIC achieves 1-bit of precision for each loop. Each increase in one bit of precision requires an additional loop to process the method, thus, to obtain 32-bits of precision CORDIC requires 32 loops, and 64 loops for 64-bit precision. To improve speed, look-up tables can be used for interpolating trigonometric functions or storing coefficients of a polynomial equations that, in turn, are used to calculate an approximate value for a trigonometric function measurement. This improves speed but loses precision.

Thus, high precision computing requires more computing time. Fast high precision computing also requires a high amount of computing resource, e.g. in needing more powerful processors. Computations of high precision geometric parameters can accordingly be bottlenecks in many applications that require intensive processing resources in order to output the trigonometric measurements in high precision.

Therefore, in currently available methods, there is typically a trade-off between precision in the calculated parameters and the processing speed and resource.

It is to be understood that, if any prior art is referred to herein, such reference does not constitute an admission that the prior art forms a part of the common general knowledge in the art, in Australia or any other country.

### SUMMARY

In one aspect, there is disclosed herein an apparatus for estimating a measurement for a geometric dimension of an object, wherein the geometric dimension is at an angle to a reference geometric dimension of the object; comprising a processor, memory storing machine-executable code, and operating system supporting computer processes. The processor is configured to implement the machine-executable code to:
receive data indicative of an input angle between the geometric dimension being measured and the reference geometric dimension;
determine an integral angle and a fractional angle, respectively being an integral portion and a fractional portion of the input angle;
determine trigonometric function values of the fractional angle;
obtain determine a first rotation matrix for a first rotation from 0 degrees to the integral angle;
determine a second rotation matrix for a second rotation by the fractional angle, based on the trigonometric function values of the fractional angle;
determine trigonometric function values of the angle between the geometric dimensions on the basis of a combination of the first and second rotation matrices;
estimate the measurement for the geometric dimension based on the trigonometric function values of the input angle and a measurement the reference geometric dimension.

In an embodiment, determining the first rotation matrix comprises the processor executing read functions to obtain trigonometric function values of the integral portion of the angle from a database.

In an embodiment, determining the first rotation matrix comprises determining matrices for a first partial rotation and a second partial rotation, the first partial rotation covering an angular range determined by a maximum number of angular steps within the integral angle, wherein each angular step covers a rotation of a predetermined integer-number of degrees, and wherein the second partial rotation covers a difference between the integral angle and the angular range.

In an embodiment, the trigonometric function values comprise sine and cosine function values.

In an embodiment, the trigonometric function values comprise sagitta values, wherein rotation matrix values are determined from the sagitta values.

In an embodiment, determining trigonometric function values of the fractional angle comprises using a truncated expansion or interpolation formula, wherein the fractional angle in degrees is used as a constant in the truncated expansion or interpolation formula, in operations comprising one or more of: an addition operation, a subtraction operation, a multiplication operation.

In an embodiment, the memory has stored therein trigonometric function values for a plurality of whole-degree angles between 0 degrees and 90 degrees.

In an embodiment, the trigonometric function values comprise sine and cosine values, or sagitta values, for the plurality of whole-degree angles.

In an embodiment, the plurality of whole-degree angles comprise all angles between 0 degrees and 90 degrees.

In an embodiment, the plurality of whole-degree angles comprise every whole-number degree between 0 degree and (N-1) degrees, and every N degrees between 0 degrees and 90 degrees, wherein N is an integer greater than or equal to two.

### BRIEF DESCRIPTION OF THE DRAWINGS

Embodiments will now be described by way of example only, with reference to the accompanying drawings in which

FIG. 1 schematically depicts processing to determine a geometric parameter, in accordance with an embodiment of the present invention;

FIG. 2-1 schematically depicts a processing to determine a trigonometric function value of an input angle, in accordance with an embodiment of the present invention;

FIG. 2-2 schematically depicts a processing to determine a trigonometric function value of an integer angle, in accordance with an embodiment of the present invention;

FIG. 2-2 schematically depicts the sagitta of an angle on a unit circle;

FIG. 3 depicts an example computer code to determine trigonometric values of an integer angle, in accordance with an embodiment of the present invention;

FIG. 4 depicts an example computer code to return the sine and cosine values of the fractional angle;

FIG. 5 conceptually depicts an example system for determining a measurement of a geometric parameter.

### DETAILED DESCRIPTION

In the following detailed description, reference is made to accompanying drawings which form a part of the detailed description. The illustrative embodiments described in the detailed description, depicted in the drawings, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure. Herein disclosed are embodiments of an apparatus and method for determining trigonometric measurements to estimate geometric parameters. The parameters may be estimated from 2D or 3D models. As will be shown, high precision calculations of trigonometric measurements can be achieved faster than using the existing methods executed by modern (e.g., x86 and x64) processors. The precision of the algorithm disclosed herein meets the IEEE 32-bit single precision standard and the IEEE 64-bit double precision standard.

Embodiments of the current method and apparatus is applicable towards providing the geometric estimates obtained from applying trigonometric measurements associated with angles from −π/2 to π/2 to a known or predetermined reference geometric measurement. However, theoretically the method may be applicable to an extended range of angles, with modularized processing of the angle measurements, utilizing the cyclical nature of trigonometric functions. The method, in some embodiments, utilizes as few as ten values in a look-up table, though the preferred number is 19.

Embodiments of the method allows for a substantially faster computation for high-precision metrics, compared with existing methods such as CORDIC. This is because a much higher precision can be achieved by processing to implement one equation, once. In contrast CORDIC achieves 1-bit of precision for each processing loop. Thus, to obtain 32-bits of precision CORDIC requires 32 loops, and 64 loops for 64-bit precision, etc.

Furthermore, embodiments of the algorithm presently described returns both the sine and cosine measurements, making this ideal for 3D visualization or any application that uses a rotation matrix in order to obtain visualization or real geometric parameters expected to match the angle. This is because a rotation matrix requires both sine and cosine as input variables. Therefore, because embodiments of the present algorithm returns both sine and cosine measurements as outputs faster than the computers opcodes currently available return either one, it makes for a considerable speed improvement.

As will be described, the ability for achieving fast, high-precision computation arises from 1) separating the input angle for which trigonometric measurements are required into an integral part and a fractional part, 2) using an approximation for an interpolation formula which is expressed in terms of the second-order difference of the sine function, and 3) truncating the formula to keep only the lower-order components, where number of components retained will depend on the precision which is needed.

Examples of the currently proposed method will be provided later in this disclosure. One example covers how to obtain estimates that utilize trigonometric measurements at a 32-bit single precision, and another example how to obtain estimates that utilize trigonometric measurements at a 64-bit double precision. While the 64-bit precision embodiments will require more computation time than the 32-bit precision embodiments, they will still be faster than the computers opcodes currently available and still meet the IEEE 64-bit double precision specification. It will be understood that these are examples only. The same strategy described herein is applicable towards generating trigonometric measurements at different precisions which can be higher or lower than the 32- and 64-bit precisions, e.g., 8-bit, 16-bit, etc. The skilled person can devise the implementations for the different precisions by following the principles disclosed herein.

The 32-bit single precision algorithm takes equation's derived from cosine and sine differences and transforms the equations using trigonometric addition theorems, then embeds these equations in Bessel's Interpolation Formula to get the final derivation. However, the equation derived makes no approximations, and is accurate to eight decimal digits, meeting the IEEE standard of 7.2247 decimal places of precision. The equation can be made more accurate if needed, by taking one or more higher order differences into account.

### Approximation for Sine Calculation

### Sine Difference Table for Integral Angles

The computations involved in the present method utilize sine differences in some cases. To facilitate computation in practical implementation, a sine difference table may be built in order to compute the values for the integral part of the angle via table look-up. The sine value for every degree is in the table, where θᵢ=i degrees, “i” being an integer. It can be shown that the second-order sine difference Δ″ for sin θᵢ is:

$${Δ}^{″} = sin {θ}_{i - 1} - 2 sin {θ}_{i} + sin {θ}_{i + 1} \qquad ( 1 )$$

Equation (1) may be expanded using the trigonometric addition theorem, as follows:

$$\begin{matrix}{Δ}^{″} = sin {θ}_{i - 1} - 2 sin {θ}_{i} + sin {θ}_{i + 1} \\ = ( sin {θ}_{i - 1} - sin {θ}_{i} ) + ( sin {θ}_{i + 1} - sin {θ}_{i} ) \\ = 2 ( cos \frac{{θ}_{i - 1} + {θ}_{i}}{2} sin \frac{{θ}_{i - 1} - {θ}_{i}}{2} + cos \frac{{θ}_{i - 1} + {θ}_{i}}{2} sin \frac{{θ}_{i - 1} + {θ}_{i}}{2} ) \\ = 2 sin \frac{1 °}{2} ( cos \frac{{θ}_{i - 1} + {θ}_{i}}{2} - cos \frac{{θ}_{i - 1} + {θ}_{i}}{2} ) \\ = - 4 {sin}^{2} \frac{1 °}{2} sin {θ}_{i}\end{matrix} \qquad ( 2 )$$

Thus it is possible, utilizing equation (2), to construct a sine difference table.

Extension into Angles Including Fractional Angles

The sine difference allows the merging of the computation results associated with the integral part of the angle and with the fractional part of the angle. The merging utilizes an interpolation. Various interpolation formulae may be used.

In some embodiments, the interpolation formula used for the computation is derived as an approximation of Bessel's Interpolation Formula. It may be derived from other available interpolation formulas may be considered by the skilled person. For example, Taylor's expansions series may be used.

Bessel's Interpolation Formula, for computing the interpolated value y is given as follows:

$$y = \frac{( {y}_{0} + {y}_{1} )}{2} + ( u - \frac{1}{2} ) Δ {y}_{0} + \frac{u ( u - 1 )}{2 !} \frac{( {Δ}^{2} {y}_{- 1} + {Δ}^{2} {y}_{0} )}{2} + \frac{u ( u - \frac{1}{2} ) ( u - 1 )}{3 !} {Δ}^{3} {y}_{- 1} + \frac{u ( {u}^{2} - 1 ) ( u - 2 )}{4 !} \frac{( {Δ}^{4} {y}_{- 2} + {Δ}^{4} {y}_{- 1} )}{2} + \frac{u ( u - \frac{1}{2} ) ( {u}^{2} - 1 ) ( u - 2 )}{5 !} {Δ}^{5} {y}_{- 2} + \qquad ( 3 )$$

The interpolation formula (3) may be used to compute the sine values needed to build the sine difference table, by using the sine function as the y function.

In the present method, the second order sine “difference” A″ is used to compute the interpolation. Therefore the interpolation formula Equation (3) is re-expressed in an approximated form that uses the difference equation (2) derived above.

In the approximation, higher order components of the interpolation are omitted so that we end up with a truncated interpolation formula. In one example, components associated differences which or higher than the third order are ignored. In the example, the first- and third-order differences are expressed in terms of the function and second differences respectively. A re-expressed, truncated equation is as follows:

$$y = {my}_{i - 1} + {ny}_{i + 1} + \frac{m ( {m}^{2} - 1 )}{3 !} \times {Δ}_{i - 1}^{″} + \frac{n ( {n}^{2} - 1 )}{3 !} \times {Δ}_{i - 1}^{″} \qquad ( 4 - 1 )$$

The form of the derived equation (4-1) is not expressed exactly as Bessel's equation above. However, it expresses the essential characteristics, and structure of the Bessel equation.

Substituting the function y with the sine function:

$$sin {θ}_{l} = m sin ( {θ}_{i - 1} ) + n sin ( {θ}_{l + 1} ) + \frac{m ( {m}^{2} - 1 )}{3 !} \times {Δ}_{i - 1}^{″} + \frac{n ( {n}^{2} - 1 )}{3 !} \times {Δ}_{i - 1}^{″} \qquad ( 4 - 2 )$$

In the case of i being an integer, i−1 and i+1 are the nearest integers on either side of i. Here, n is the difference between the input angle (i degrees) and the nearest “left hand side” angle which is less than the input angle, i.e., i−1 degrees. m=1−n.

The concept of utilizing “nearest integral angles” on either side of an input angle θ is used to extend the above equation (4-2) into calculation of angles which are not entirely integral, i.e., comprising fractional components.

In the case of an input angle θ comprising a fractional component, the two “nearest” integral angles to θ, one on each side of θ, are j and j+1. That is, j<θ<j+1. Using “j” and “j+1” respectively in the place of the angles “i−1” and “i+” in equation 4-2, results in equation 4-3 below:

$$sin θ = m sin {θ}_{j} + n sin {θ}_{j + i} + \frac{m ( {m}^{2} - 1 )}{3 !} \times {Δ}_{j}^{″} + \frac{n ( {n}^{2} - 1 )}{3 !} \times {Δ}_{j - 1}^{″} \qquad ( 4 - 3 )$$

In equation (4-3), n=0-j; m=1−n.

More generally, using the function u as a general term in place of sine or cosine functions for non-integral angles, equation 4-3 is written as equation 4-4:

$$μ ( θ ) = m μ ( {θ}_{j} ) + n μ ( {θ}_{j + i} ) + \frac{m ( {m}^{2} - 1 )}{3 !} \times {Δ}_{j}^{″} + \frac{n ( {n}^{2} - 1 )}{3 !} \times {Δ}_{j - 1}^{″} \qquad ( 4 - 4 )$$

Equation 4-4 can be applied for the fast determination of the trigonometric functions, where the derived equation is restricted to a domain where computations are performed for angles θ between zero and one degrees, i.e., the fractional component of the input angle. However, the full range from −π/2 to +π/2 or greater is possible.

Return back to equation (4-4), this can be further modified by expressing the second order difference Δ″ is expressed as sine or cosine functions as required by the function value which is being approximated.

When solving for a sine function measurement, the expression for Δ″ can be substituted into our derived Bessel Equation above by setting Pₘ and Pₙ as the following:

$${P}_{m} \times μ ( {θ}_{j} ) = \frac{m ( {m}^{2} - 1 )}{3 !} \times {Δ}_{j}^{″} ; {P}_{m} = \frac{m ( {m}^{2} - 1 )}{3 !} \times \frac{{Δ}_{j - 1}^{″}}{u ( {θ}_{i} )} \qquad ( 5 )$$

$${P}_{n} \times μ ( {θ}_{j + 1} ) = \frac{n ( {n}^{2} - 1 )}{3 !} \times {Δ}_{j + 1}^{″} ; {P}_{m} = \frac{n ( {n}^{2} - 1 )}{3 !} \times {Δ}_{j - 1}^{″} ; {P}_{m} = \frac{n ( n - 1 )}{3 !} \times \frac{{Δ}_{j - 1}^{″}}{u ( {θ}_{j + 1} )} \qquad ( 6 )$$

Utilizing equations (5) and (6), where u(θᵢ) is sin θᵢ and u(θᵢ₊₁) is sin 0ᵢ₊₁ and expressing the second order difference Δ″ in term of the sine function as in equation (2), the following expression is obtained for calculating the sine function.

$$sin θ = ( m + {P}_{m} ) sin {θ}_{j} + ( n + {P}_{n} ) sin {θ}_{j + 1} \qquad ( 7 )$$

Where θ; <0<0ⱼ₊₁, θ being the input angle, θⱼbeing the lower bound integral angle; θⱼ₊₁ being the upper bound integral angle; n=0−θⱼ, i.e., the fractional part of the input angle θ.

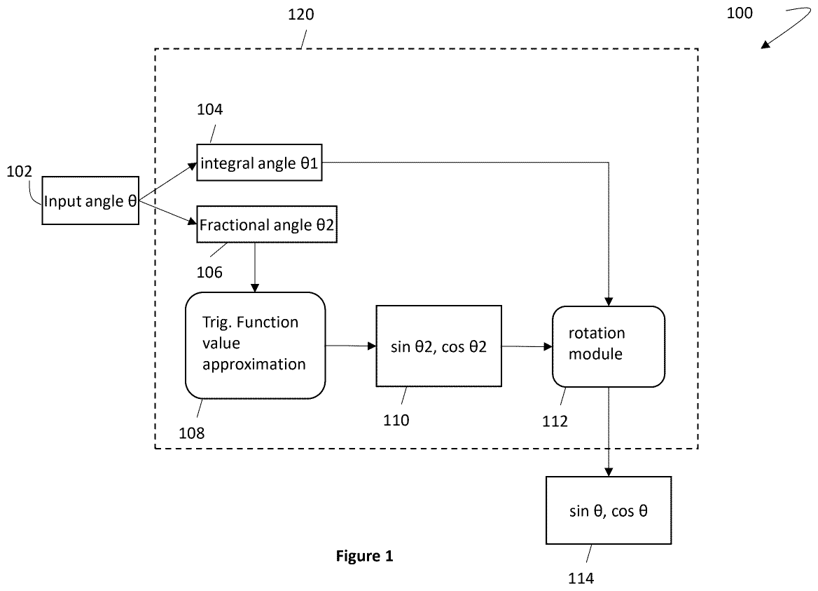

As will be seen later with reference to FIG. 1, the above equation will be used to calculate the sine values for the fractional part of the input angle separately. That is, θ=n, and the domain of the angle in question is restricted to between zero and one degrees. For the fractional angle n, θⱼ₌₀ degrees, and θⱼ₊₁=1 degree. The values for sin θⱼand sin θⱼ₊₁ therefore become represented by constants.

$$sin {θ}_{j} = sin 0 = 0 \qquad ( 8 )$$

$$sin {θ}_{j + 1} = sin 1 = 0. 01745240644 \qquad ( 9 )$$

The value for sin 1′ can be saved in memory to be readily accessible, or the system may perform a look up operation. Thus, our derived equation for the sine of the fractional angle n:

$$\begin{matrix}sin n = ( m + {P}_{m} ) sin {θ}_{j} + ( n + {P}_{n} ) sin {θ}_{j + 1} \\ = ( n + {P}_{n} ) 0. 01745240643728351\end{matrix} \qquad ( 10 )$$

In equation (10), Pₘ is not required as sin θⱼgoes to zero. Therefore, only Pₙ needs to be calculated. Combining equations (2) and (6) results in:

$${P}_{n} = 4 {sin}^{z} \frac{1 °}{2} \frac{n ( 1 - {n}^{2} )}{3 !} \qquad ( 11 )$$

However, the majority of the equation (11) for Pₙ above can be written as a constant:

$$4 {sin}^{2} ( \frac{1 °}{2} ) \cdot \frac{1}{3 !} = constant$$

Hence:

$${P}_{n} = 4 {sin}^{2} \frac{1 °}{2} \frac{n ( 1 - {n}^{2} )}{3 !} = 0. 00005076828120291 n ( 1 - {n}^{2} ) \qquad ( 12 )$$

Therefore, the calculation for the sine value of the fraction angle θ=n degrees can be performed by combining equations (10) and (12), resulting in an approximated formula which the calculation only involves n as a variable. As n is the fractional part of the angle, in degrees, no conversion to radians would be required.

This makes for an extremely fast calculations for the value for sine for angles n between zero and one degree. This is up to twenty times faster than using the currently available algorithm for computing values of sine of angles which are less than one degree.

Equation (12) is still relevant for all angles. To obtain the trigonometric calculation for the input angle, from the result of the sine approximation for the fractional angle n, an extra rotation is required. This will be made clear later in the disclosure.

These equations mentioned in the above are exact up to eight decimal places, this can be extended by taking one or more higher-order difference into account and adjusting the derivation for the interpolation function, i.e., in the example this is the derivation for the Bessel Equation. However, the IEEE 32-bit single precision standard, only requires 7.2247 decimal digits of precision. Therefore, embodiments which include up to the third-order difference is all that is required to meet the IEEE 32-bit single precision standard.

The following are examples of applying the above explained embodiment.

### Example 1-Apply the Embodiment for Solving the Sine of 0.385 Degrees Up to 32-Bit Precision

As mentioned above, the calculation for sin θ where θ is 0.385 degrees, can be approximated using Equations (10) and (12), because 0.385 degrees is a fractional angle. This is shown in more detail below.

Given θ=0.385 degrees, θ_{j=0.}

Thus sin θⱼ=sin 0=0, therefore m and Pₘ are not required as sin θⱼgoes to zero.

Hence, n degrees=θ−θⱼ;
Therefore n degrees=0.385 degrees−0=0.385 degrees

$$\begin{matrix}{P}_{n} = 0. 00005076828120291 \cdot n ( 1 - {n}^{2} ) \\ = 0. 00005076828120291 \cdot 0. 385 ( 1 - 0. 148225 ) \\ = 0.00001664861\end{matrix}$$

Applying the value of Pₙ to Equation (10) gives:

$$\begin{matrix}sin θ = ( n + Pn ) 0. 01745240643728351 \\ sin ( 0.385 degrees ) = ( 0.385 + 0.00001664861 ) \cdot 0.01745240643728351 \\ sin ( 0.385 degrees ) = ( 0.385001664861 ) \cdot 0.01745240643728351 \\ sin ( 0.385 degrees ) = 0.00671946703\end{matrix}$$

(Accurate to 10 Decimal Places, which Meets the IEEE 32-Bit Single Precision Standard of 7.2247 Decimal Digits of Precision)

### Approximation for Arcsine Calculation

The derived equation for sine flows naturally into a solution for Arcsine, especially for values within the restricted domain of between zero and one.

The derived equation from the sine of the angle θ was expressed as equation (10):

$$sin θ = ( m + {P}_{m} ) sin {θ}_{j} + ( n + {P}_{n} ) sin {θ}_{j + 1}$$

Recall that Pₘ is not required as sin θⱼgoes to zero for a fractional angle as sin θⱼ₌₀, therefore to compute the above, only Pₙ is required. Pₙ was determined from equations (6) and (12), which allows for a simplification to equation (10). These equations are below.

$$\begin{matrix}{P}_{n} = 4 {sin}^{2} \frac{1 °}{2} \frac{n ( 1 - {n}^{2} )}{3 !} \\ {P}_{n} = 4 {sin}^{2} \frac{1 °}{2} \frac{n ( 1 - {n}^{2} )}{3 !} = 0.00005076828120291 n ( 1 - {n}^{2} ) \\ sin θ = ( n + {P}_{n} ) 0. 01745240643728351 ,\end{matrix}$$

where 0<θ<1; n degrees=θ−θⱼ;

Therefore, to find the Arcsine, we only need to plug the sine value into the equation and solve for an approximate arcsine value that is also at the required number of decimal places of accuracy. See example below.

### Example. Solve for the Arcsine of: 0.00671946703

Using equation (10),

$$sin ( θ ) = 0. 00671946705 = ( n + Pn ) 0. 01745240643728351$$

$$\frac{0.00671946705}{0.01745240643728351} = ( n + {P}_{n} )$$

$$0.3850166496 = ( n + {P}_{n} )$$

Once Pₙ is expressed as a function of n as shown above, the equation for sin θ can be expressed as a polynomial equation of n, and we can solve for n to find the arcsine value.

In an embodiment, rather than solving the polynomial equation, the method uses a less resource-intensive solution whereby the value n+Pₙ is used to approximate the value of n, as the value of Pₙ is expected to be insignificant compared to n. This is the first step. In a second step, the approximated value of n is used in equation (12) to find an approximate value for Pₙ. In the third step, the approximated value for Pₙ is plugged into equation (10)

In this example, n+Pₙ is determined above to approximately be 0.3850166496. Therefore, setting n=0.3850166496 in equation (12):

$$Pn \approx 0. 00005076828120291 n ( 1 - {n}^{2} )$$

$$Pn \approx 0. 00005076828120291 ( n - {n}^{3} )$$

$$Pn \approx 0.00005076828120291 ( 0.3850166496 - 0.05707402898 )$$

$$Pn \approx 0.00001664908$$

Plugging the obtained approximate value for Pₙ back into Equation (10), an approximate solution for the Arcsine of 0.00671946703 is determined:

$$0.3850166496 = ( n + 0. 00001664908 )$$

$$0.3850166496 - 0. 00001664908 = n$$

$$0.3850000005 = n$$

Hence the Arcsine (0.00671946703)=0.3850000005 Degrees

This is accurate to nine decimal places. In another embodiment which provides more accuracy, the calculated value for the arcsine can be used as n in equation (12) to re-approximate for Pₙ again, then subtract the calculated Pₙ value from the arcsine variable (i.e., 0.3850166496), this is accurate to approximately 13 decimal places. The computation to obtain the 13 decimal place accuracy is extremely fast compared to the computer's arcsine function.

### Approximation for Cosine Calculation

### Cosine Difference Table for Integral Angles

Similar to the sine difference table, we can build a cosine difference table, where the cosine value for every integer degree is in the table, where θᵢ=i degrees, “i” being an integer. Then it can be shown that the second difference opposite cos θᵢ is:

$${Δ}^{″} = cos {θ}_{i - 1} - 2 cos {θ}_{i} + cos {θ}_{i + 1} \qquad ( 13 )$$

Expanding equation (13) using a trigonometric addition theorem, the following is obtained:

$$\begin{matrix}{Δ}^{″} = cos {θ}_{i - 1} - 2 cos {θ}_{i} + cos {θ}_{i + 1} \\ = ( cos {θ}_{i - 1} - cos {θ}_{i} ) + ( cos {θ}_{i + 1} - cos {θ}_{i} ) \\ = 2 ( sin \frac{{θ}_{i - 1} + {θ}_{i}}{2} sin \frac{{θ}_{i - 1} - {θ}_{i}}{2} + sin \frac{{θ}_{i + 1} + {θ}_{i}}{2} sin \frac{{θ}_{i + 1} - {θ}_{i}}{2} ) \\ = 2 cos {θ}_{i - 1} ( 1 - cos 1 )\end{matrix} \qquad ( 14 )$$

### Cosine Value Calculation Using Bessel's Interpolation for Non-Integral Angles

Recall the derived Bessel Equation obtained by expressing the first and third differences in terms of the second order difference:

$$y = m {y}_{i - 1} + n {y}_{i + 1} + \frac{m ( {m}^{2} - 1 )}{3 !} \times {Δ}_{i - 1}^{″} + \frac{n ( {n}^{2} - 1 )}{3 !} \times {Δ}_{i + 1}^{″}$$

where i−1 and i+1 represent the nearest integral values on either side of integer i. boundary values of the function: i−1<i<i+1, n=i−(i−1), and m=1−n.

Using the cosine function as the function “y” in the above derived Bessel Equation:

$$cos {θ}_{i} = m cos ( {θ}_{i - 1} ) + n cos ( {θ}_{i + 1} ) + \frac{m ( {m}^{2} - 1 )}{3 !} \times {Δ}_{i - 1}^{″} + \frac{n ( {n}^{2} - 1 )}{3 !} \times {Δ}_{i + 1}^{″} \qquad ( 15 - 1 )$$

In the case of an input angle θ which is not purely integral in value, the upper and lower bounds, i.e., nearest integer values on either side of input θ, can be expressed as: θⱼ<θ<θⱼ₊₁

Therefore, setting θⱼand θⱼ₊₁ in place of the lower and upper bounds θⱼ−1 and θⱼ₊₁ in equation 15-1:

$$cos θ = m cos {θ}_{j} + n cos {θ}_{j + 1} + \frac{m ( {m}^{2} - 1 )}{3 !} \times {Δ}_{j}^{″} + \frac{n ( {n}^{2} - 1 )}{3 !} \times {Δ}_{j}^{″} \qquad ( 15 - 2 )$$

Utilizing equations (5) and (6) for Pₘ and Pₙ, with cosine being the function being evaluated, the following can be written:

$$cos θ = ( m + {P}_{m} ) cos {θ}_{j} + ( n + {P}_{n} ) cos {θ}_{h + 1} \qquad ( 15 - 3 )$$

$$Where {θ}_{j} < θ < {θ}_{j + 1} ; n = θ - {θ}_{j} ; m = 1 - n ;$$

From the trigonometric identity theorem, the Pₘ and Pₙ for cosine are derived as:

$${P}_{m} = 2 cos {θ}_{j} ( 1 - cos 1 ) \frac{m ( 1 - {m}^{2} )}{3 !} \qquad ( 16 )$$

$${P}_{n} = 2 cos {θ}_{j} ( 1 - cos 1 ) \frac{n ( 1 - {n}^{2} )}{3 !} \qquad ( 17 )$$

Again, these equations are exact up to eight decimal places, and can be extended to accuracy up to more decimal places, by taking the upper order difference(s) into account.

As with Pₘ and Pₙ for sine, the values of Pₘ and Pₙ for the cosine also have a large part of the equation that can be made into a constant, when the input angle θ is restricted to between zero and one degrees, this forces cos θⱼinto a constant of cos (0), and thus Pₘ and Pₙ for cosine functions are as follows:

$${P}_{m} = 2 cos ( 0 ) * ( 1 - cos ( 1 ) ) * m ( 1 - {m}^{2} ) / 3 !$$

$${P}_{n} = 2 cos ( 0 ) * ( 1 - cos ( 1 ) ) * n ( 1 - {n}^{2} ) / 3 !$$

The value of 2 cos (0)*(1−cos (1)) is calculated at 0.00005076828120291

Therefore, restricting the domain of the angles to between zero and one degrees allows for the utilization of the above value as a constant, and gives the following:

$${P}_{m} = 2 cos ( 0 ) ( 1 - cos ( 1 ) ) \frac{m ( 1 - {m}^{2} )}{3 !} = 0.00005076828120291 m ( 1 - {m}^{2} ) \qquad ( 18 )$$

$${P}_{n} = 2 cos ( 0 ) ( 1 - cos ( 1 ) ) \frac{n ( 1 - {n}^{2} )}{3 !} = 0.00005076828120291 n ( 1 - {n}^{2} ) \qquad ( 19 )$$

The final derived equation to solve for cosine is therefore expressed as equation 15-3:
cos θ=(m+Pₘ) cos θⱼ+ (n+Pₙ) cos θⱼ₊₁, where 0<θ<1; n=θ−θⱼ; and
Pₘ and Pₙ are as calculated above.

### Example: Solving for the Cosine of 0.385 Degrees

In this case, n=0.385−0=0.385 degrees. Therefore, m=1−n=1−0.385=0.615 degrees. Therefore, using our equations (15-3), (18), and (19),

$$\begin{matrix}{P}_{n} = 0. 00005076828120291 \cdot n ( 1 - {n}^{2} ) \\ = 0. 00005076828120291 \cdot 0. 385 ( 1 - 0. 148225 ) \\ = 0.00001664861\end{matrix}$$

$$\begin{matrix}{P}_{m} = 0.00005076828120291 m ( 1 - {m}^{2} ) \\ = 0. 00005076828120291 \cdot 0. 615 ( 1 - 0. 378225 ) \\ = 0.00001941336\end{matrix}$$

Given the boundary condition of 0<θ<1, that θⱼ₌₀ and θⱼ₊₁=1. Therefore:

$$\begin{matrix}cos θ = ( m + Pm ) cos {θ}_{j} + ( n + Pn ) cos {θ}_{j + 1} \\ = ( m + Pm ) cos ( 0 ) + ( n + Pn ) cos ( 1 )\end{matrix}$$

Solving the above equation gives with the computed values for Pₘ and Pₙ gives:

$$cos ( 0.385 ) = ( 0.6 15 + 0.000019413 \; 36 ) * 1. + ( 0.3 85 + 0.000016648 \; 61 ) * 0.9998476952 = 0.9999774221$$

The above value is accurate to 8 decimal places, which meets the IEEE 32-bit single precision standard of 7.2247 decimal digits of precision.

Non-Integral Angles Greater than One Degree

In the above, the approximations and calculations have been demonstrated for “fractional” angles that are between zero and one degrees.

The use of the functions to calculate the sine and cosine of “fractional angles”, and to arrive at the sine and cosine values for angles which are greater than one degree, is discussed below.

An embodiment of the algorithm is described below with reference to FIG. 1, which schematically depicts a system 100 for determining trigonometric function values of input angles. In this and other embodiments, the input angle θ 102 is provided as an input into the system 100. It is split into an integral angle 104 and a fractional angle 106. The integral angle 104 corresponds to the integral part of the input angle 102, being the nearest whole degree angle which is less than the input angle. The fractional angle 106 which is less than 1 degree corresponds to the fractional part of the input angle 102. The fractional angle 106 is passed as input to an approximation module 108 which estimates the sine or cosine values, or both, of the fractional angle 106, whichever is needed. Thus the approximation module will be configured to implement the algorithms described above in relation to the calculation of sine and cosine values of fractional angles. The output 110 from the approximation module 108 and the integral angle 104 are used by the rotation module 112 to determine approximated trigonometric (e.g., sine, cosine) function values for the input angle 102.

The rotation module 112 is configured to implement algorithms to produce the trigonometric function values for the input angle, where the integral and fractional angles 104, 106 are used to achieve the rotation required to compute the sine and cosine values of the input angle. The box 120 in dashed line conceptually represents the computing device or system which implements the processing.

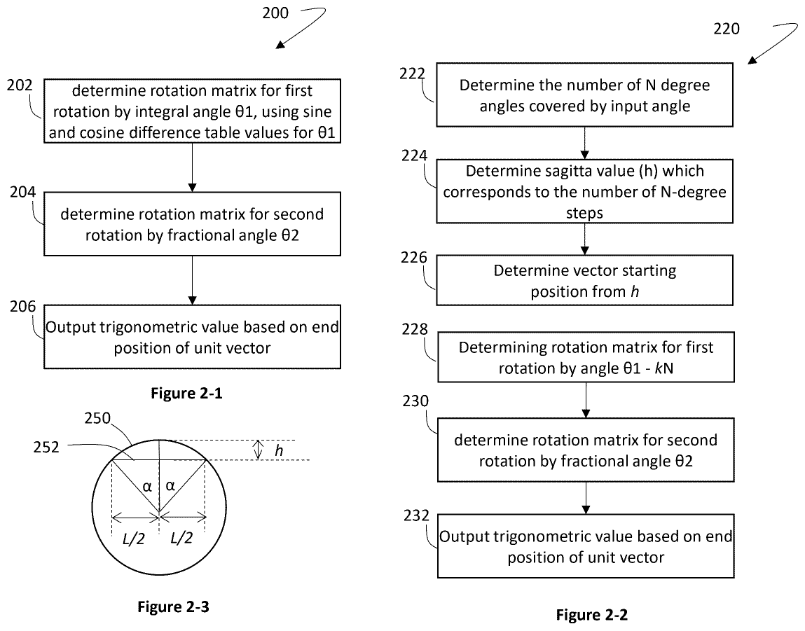

An example process 200 implemented by the rotation module 112 is described with reference to FIG. 2-1. The rotation module 112 applies two rotations to a vector with a magnitude of 1, within a Cartesian coordinate system for determining the sine and cosine values. This is a geometric vector used for calculating the trigonometric functions. From a starting position in which the vector aligns with the direction from (0, 0) to (1, 0), it is rotated by an angular amount which is the integral angle 104, in a first rotation. To implement this rotation, a rotation matrix determined using the sine and cosine values of the integral angle applied to the unit vector at step 202. The sine and cosine values of the integral angle may be read from a database containing the sine and cosine values for integral angles, e.g., from a memory location storing the sine and cosine values approximated as discussed above in relation to the sine and cosine difference tables.

The sine and cosine values of the fractional angle 106 as determined by the approximation module 108 will be used to provide a second rotation matrix at step 204. This will be used to apply a second rotation to the vector in the amount of the fractional angle. For instance, to calculate the sine and cosine of 23.385 degrees, the trig calculation vector is rotated to the integral angle (23 degrees) in the first rotation, and then the sine and cosine values for the fractional angle (0.385 degrees) are determined to obtain the rotation matrix for the second rotation. The steps 202 and 204 may be performed in the reverse order.

At step 206, the sine and cosine values for the input angle are determined on the basis of (x, y) coordinates of the resulting position of the rotated unit vector. The algorithm to achieve this rotation is set up so that only two rotations are required to achieve the values. Unlike the CORDIC (Coordinate Rotation Digital Computer) method, which requires 32 or 64 rotations this method with only two rotations, and is extremely fast. The final, second, rotation is exact to within the IEEE standards.

A modified process 220 implemented by the rotation module 112 is described with reference to FIG. 2-2. Here, the rotation matrix for implementing the first rotation to reach the integral angle is determined in a different way. In this embodiment, the vector is moved to a different starting position so that it does not align with the direction from (0, 0) to (1, 0).

The starting position is determined by the number (k) of fixed-degree steps within the input angle. Each fixed degree is a fixed integral number (N) of degrees. In the starting position, the vector will have an angle of α=kN from the x-axis. For example, the fixed-degree steps may be 5-degree steps (N=5). To illustrate, the angle of 23.385 degrees has four 5-degree steps. Therefore the unit vector has a starting position defined by an angle of 20 degrees. In other embodiments, N may be a different number. For instance N may be 10-degree steps, in which case the starting position is also set by 20 degrees as there are two 10-degree steps in the angle of 23.385 degrees. However, if N is 6, then the starting position is set by the angle of 18 degrees, because there are three 6-degree steps in the angle of 23.385 degrees.

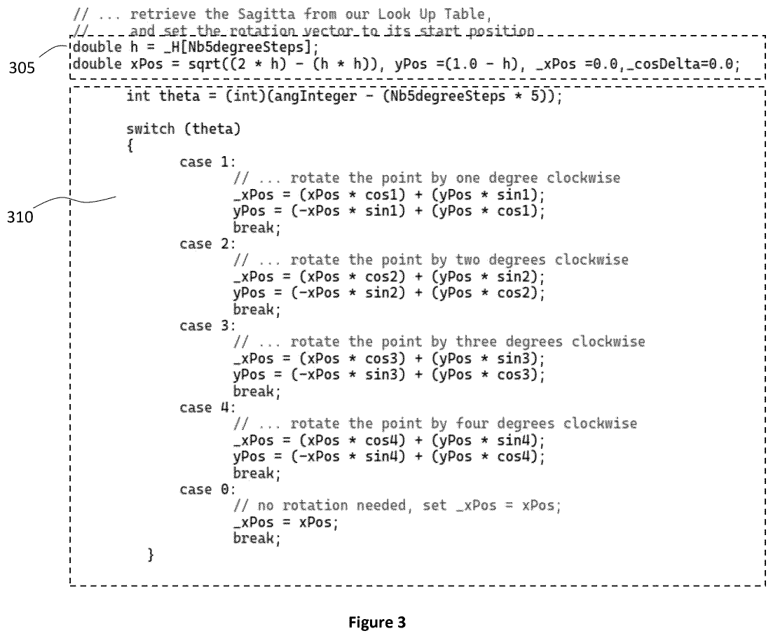

At step 224, once the number k of fixed-degree steps is determined, a value called a “Sagitta” h is determined, in respect of an angle α=kN. A geometric representation of h is shown in FIG. 2-3. The sagitta h is the height of an angle of 2α, at the mid-point of the arc 250 covering the angle 2α, relative to the midpoint of the cord 252 corresponding to the arc 250. The h value may be retrieved from a Look Up Table. At step 226, h is used to calculate both the sine and cosine values of the start angle α, as the values define the (x, y) coordinates of the starting position of the vector. This is set as the start position of the first rotation to be applied to the rotation vector. At step 228 the rotation matrix for applying a first rotation by an angle of 01-kN is determined. At the finishing position of the first rotation, the vector is positioned at the integral angle θ1 of the input angle. There are (N-1) possibilities as to what the angle θ1-kN can be. Therefore, this can be implemented in computing systems using switch statements or similar, where the rotation matrix is hardcoded into the switch statements. The use of the look up table (whether the difference tables or the sagitta table), and the switch statements, means that the memory required to store the values is minimised, and yet the algorithm is still able to return outputs of estimated trigonometric function values must faster than prior art algorithms.

At step 230, a rotation matrix for applying the fractional angle θ2 is determined, for applying the second rotation. The required trigonometric value for the input angle θ is determined at step 232 from the end position of the unit vector after the second rotation.

As can be appreciated, with a smaller N, more h values must be stored, the but starting position is more likely to be closer to the actual input angle. Therefore, the choice of N can be made by the skilled person, having regard to the memory availability of the device on which the algorithm is being implemented. However, if N is at least two, then the number of h values which need to be stored is still fewer than the number of sine or cosine values that need to be stored. Further, rather than storing sine and cosine values separately, only an h value is needed for each N-degree angular increment. Therefore, the embodiment shown in FIG. 2-2 will require less memory than the embodiment shown in FIG. 2-1.

The implementations described with reference to FIGS. 1, 2-1, and 2-2, and generalized embodiments, provide a technical method for utilizing computing resources to output trigonometric values.

Sagitta value Look-Up Table

The sagitta values (h) mentioned above are determined for a circle with a radius of 1. For a small table, only ten values of h are needed to calculate trigonometric values from −90 to +90 degrees, moving clockwise in 10-degree increments. The values of h for the negative angles are identical and do not require separate storage. The preferred embodiment is to use 5-degree increments, moving clockwise, requiring 19 values in the table. The choice of the table size depends on preference or available memory.

The Sagitta h allows us to quickly calculate the sine and cosine at any increment in the lookup table.

The calculations use the following formulas for the sine and cosine of the values in the look-up table:

$$sin α = sqrt ( 2 h - {h}^{2} ) \qquad ( 20 )$$

$$cos α = 1 - h \qquad ( 21 )$$

On the other hand, instead of utilizing sagitta values, if memory capacity allows, the sine and cosine values for the angle α, where α=kN, k=0,1, 2, etc, can be directly pre-computed and stored.

Returning back to the example where the input angle is 23.385 degrees, and the fixed-steps are 5-degree steps, the starting vector position is set at 20 degrees, because there are four 5-degree steps in the input angle. The first rotation is applied to rotate the vector to the nearest whole angle relative to the input angle. As we have already set the rotation vector to the nearest 5-degree step, there are only 4 possible rotations remaining for this “first rotation”, i.e., rotating by 1 degree, 2 degrees, 3 degrees, or 4 degrees. For an input angle of 23.385 degrees, our vector is set to start from 20 degrees, requiring us to rotate the final 3-degrees in the first rotation. In order to cover the four possible remaining rotations with only one rotation, the algorithm uses a fast switch statement. An example of a fast switch statement is shown in FIG. 3, for fast switching between four possible rotations from the nearest 5-degree step. The code shown in FIG. 3 shows the step of setting the starting vector position 305, and also the fast switching step 310 to apply the first rotation from the starting vector position.

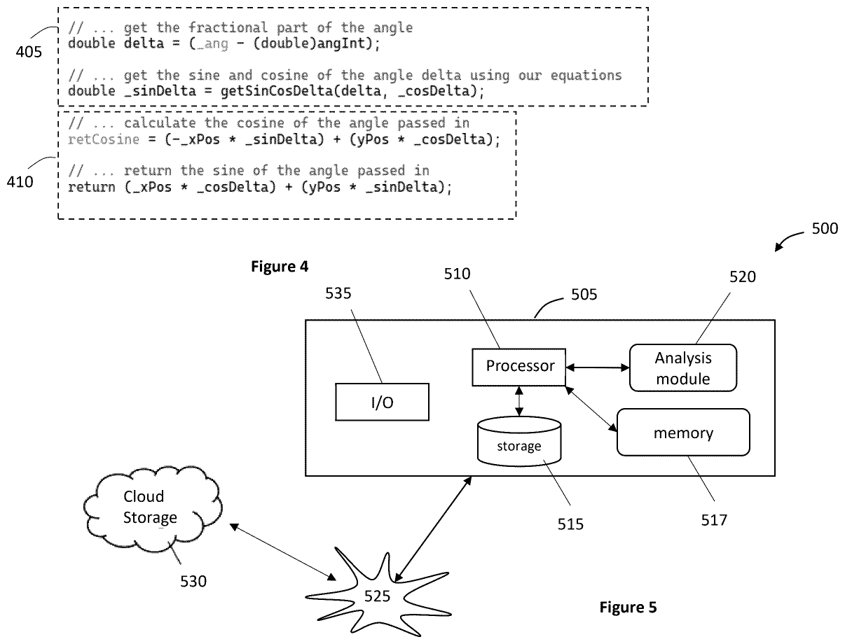

The next rotation is applied to further rotate the vector by the fractional angle or “delta” 106 to reach the final position matching the input angle, to provide the sine and cosine values of the input angle. The algorithms for calculating the sine and cosine values for fractional angles described above are used to calculate the rotation matrix R in order to perform this further rotation. The “final” sine and cosine values of input angle θ is obtained by applying the further rotation at the fractional angle Δ. FIG. 4 shows an example code for the further rotation, where calculation of the sine and cosine of the fractional angle is performed at 405, and this is used to return sine and cosine of the input angle at 410. In FIG. 4 the expression “delta” is used to denote the fractional angle. From FIG. 4, it can be seen that some computations, such as the calculations to determine the amount of delta (i.e., the fractional angle) and the sine and cosine values of delta, do not necessarily need to be done before other calculation steps. For instance the calculations to apply the first rotation matrix from the starting position may be done beforehand.

In scenarios where the sine and cosine values are required to be accurate to more than 8 decimal places, this may require solutions which return the values in 64-bits or more. In these cases, the equations derived from the Bessel's interpolation formula or the Taylor expansion series can be expanded to include higher order terms.

In the solution above for returning values with 8 decimal place accuracy, the Bessel's interpolation formula was re-expressed in terms of the second order differences in equation 4-4:

$$μ ( θ ) = m μ ( {θ}_{j} ) + 𝔫 μ ( {θ}_{j + 1} ) + \frac{m ( {m}^{2} - 1 )}{3 !} \times {Δ}_{j}^{″} + \frac{n ( {n}^{2} - 1 )}{3 !} \times {Δ}_{j + 1}^{″}$$

where θⱼand θⱼ₊₁ are boundary values of the angle θ: θⱼ<θ<θⱼ₊₁, where j is an integral value, n=θ−θⱼ, and m=1−n.

Recall Equation 7 for computing the sine value of a fractional θ:

$$sin θ = ( m + {P}_{m} ) sin {θ}_{i} + ( n + {P}_{n} ) sin {θ}_{i + 1} \qquad ( 7 )$$

where

$${P}_{m} = \frac{m ( {m}^{2} - 1 )}{3 !} {Δ}_{j}^{″} = 4 {{sin}^{2} ( \frac{1}{2} )}^{°} \frac{m ( 1 - {m}^{2} ) )}{3 !}$$

$${P}_{n} = \frac{n ( {n}^{2} - 1 )}{3 !} {Δ}_{j + 1}^{″} = 4 {{sin}^{2} ( \frac{1}{2} )}^{°} \frac{n ( 1 - {n}^{2} )}{3 !}$$

To take the accuracy to 11 digits after the decimal point, the Bessel interpolation formula as re-expressed in second-order difference terms is expanded to include third-order difference terms. For a function u for an input θ which is bound between θⱼand θⱼ₊₁, the expanded interpolation is as follows:

$$μ = m {μ}_{j} + n {μ}_{j + 1} + \frac{m ( {m}^{2} - 1 )}{3 !} \times {Δ}_{j}^{″} + \frac{n ( {n}^{2} - 1 )}{3 !} \times {Δ}_{j + 1}^{″} + \frac{( 2 - m ) m ( 1 - {m}^{2} )}{4 !} \times {Δ}_{j}^{′′′} + \frac{( 2 - n ) n ( 1 - {n}^{2} )}{4 !} {Δ}_{j + 1}^{′′′} \qquad ( 22 )$$

Using the above expanded expression to find the value of sin 0, equation (22) is re-written as the following:

$$sin {θ}_{j} = m sin ( {θ}_{j} ) + n sin ( {θ}_{j + 1} ) + \frac{m ( {m}^{2} - 1 )}{3 !} \times {Δ}_{j}^{″} + \frac{n ( {n}^{2} - 1 )}{3 !} \times {Δ}_{j + 1}^{″} + \frac{( 2 - m ) m ( 1 - {m}^{2} )}{4 !} {Δ}_{j}^{′′′} + \frac{( 2 - n ) n ( 1 - {n}^{2} )}{4 !} {Δ}_{j + 1}^{′′′} \qquad ( 23 )$$

The third order difference terms in equation (23) are further re-expressed as Pₘ₂ and Pₙ₂ as follows:

$${P}_{m 2} \times sin {θ}_{j} = \frac{( 2 - m ) m ( 1 - {m}^{2} )}{4 !} \times {Δ}_{j}^{′′′} ; {P}_{m 2} = \frac{( 2 - m ) m ( 1 - {m}^{2} )}{4 !} \times \frac{{Δ}_{j}^{′′′}}{sin {θ}_{j}} \qquad ( 24 )$$

$${P}_{n 2} \times sin {θ}_{j + 1} = \frac{( 2 - n ) n ( 1 - {n}^{2} )}{4 !} \times {Δ}_{j + 1}^{′′′} ; {P}_{n 2} = \frac{( 2 - n ) n ( 1 - {n}^{2} )}{4 !} \times \frac{{Δ}_{j + 1}^{′′′}}{sin {θ}_{j + 1}} \qquad ( 25 )$$

Using the expressions Pₘ₂ and Pₙ₂ in equation 23 results in:

$$sin θ = ( m + {P}_{m} + {P}_{m 2} ) sin {θ}_{j} + ( n + {P}_{n} + {P}_{n 2} ) sin ( {θ}_{j + 1} ) \qquad ( 26 )$$

Where θⱼ<θ<θⱼ₊₁; n=θ−θⱼ; m=1−n;

As before, by restricting the domain to between zero and one degrees the values for sin θⱼand sin θⱼ₊₁ become constants, where:
sin θⱼ=sin 0=0; sin θⱼ₊₁=sin 1=0.01745240644

Thus, equation (24) becomes: sin θ=(n+Pₙ+Pₙ₂)×0.01745240644

Therefore only Pₙ and Pₙ₂ need to be calculated, which can be done using equations (12) and (25). For the third order difference terms Δⱼ′″ and Aⱼ₊₁′″, which are needed to calculate the values of Pₙ₂, again, trigonometric theorems can be used to find an expression as was done for the second order terms. The values of these expressions can be computed using the boundary conditions which have been placed on the input angle, i.e., 0 degrees<θ<1 degree. The value is used to calculate Pₙ₂.

Going back to the example of 0=0.385 degrees, the boundary conditions placed on θ allows several terms for the expression of Pₙ₂ to be written as a constant, giving the final form:

$${P}_{n 2} = ( 2 - n ) n ( 1 - {n}^{2} ) 1.9330640170737148 e - 9$$

Therefore:

$$sin θ = ( n + {P}_{n} + {P}_{n 2} ) 0 \text{.1745240643728351}$$

If we use our previous example for the sine of 0.385 degrees, to 11 digits of accuracy, we get:

$$sin ( 0.385 ) = 0.0067194670545961$$

The above approach can be further expanded to include higher order terms for an even higher degree of accuracy. For example it can be extended to include fourth order terms to take the accuracy to 14 digits

The above equations are exact at least to stated number of decimal places, depending on how far the main equation is extended to include the higher order differences. There are no loops required in coding the equations, as in CORDIC (Coordinate Rotation Digital Computer) which improves bit precision by one bit with each loop. For example, CORDIC would require 32 loops to get the equivalent decimal precision for IEEE 32 bit and 64 loops for IEEE 64 bit.

The 64-bit double precision version of this equation, which takes the fourth difference into account meets the IEEE 64-bit standard, but does not require the 64 loops of computation.

By restricting the domain to between 0 and 1 degree, half of the equation for sine goes to zero, and therefore can be ignored, further improving performance.

It was also be shown that even though the domain for the main equation is restricted to between 0 and 1 degrees, the algorithm can cover all values between 0 and 2π. The inventor has found that the speed at which the trigonometric values are calculated is many times faster than the standard C++ library, especially for 32-bit systems.

This is because in the equations, constants such as Pₘ, Pₘ₂, Pₘ₃ etc, and Pₙ, Pₙ₂, Pₙ₃, etc, can be expressed as constants during the sine and cosine value calculations. Pre-storing these values in the memory of the calculating system makes the mathematical processing fast, requiring only multiply, add and subtract functions, with no division.

With CORDIC and other methods finding the trigonometric value for the fractional part of the angle is a time-consuming search. By restricting our domain for the above equations to zero and one degree we can use these equations to find the sine and cosine for the fractional part of the angle quickly, with no repeating loops.

The below table compares the average function call times, over 1000 calls, for the standard C++ library functions to compute the sine and cosine functions, and also for the novel algorithm utilizing sagitta h as described above. This demonstrates that on average, the novel algorithm leads to a significant advantage in the form of a reduced average function call time, compared with the standard library function.

| | | Average call time (over |
|---|---|---|
| Function | Time to process | 1000 function calls) |
| Std:Lib sin( ) & cos( ) | 10 μs | 0.01 μs |
| MyFunction SinCos( ) | 6 μs | 0.006 μs |

In the testing conducted, the angles passed into the functions were floating point numbers between −π/2 and +π/2, in steps of 0.2 degrees. The tests were run on a Windows 64-bit system with an Intel® i9-12900KF 2.3 Gigahertz processor and 64 GB random access memory. The testing showed that the novel algorithm leads to a 40% improvement in speed, and returned values accurate to 15 digits after the decimal point.

Variations and modifications may be made to the parts previously described without departing from the spirit or ambit of the disclosure.

For example, in the above, the calculation of the function value estimation was based on Bessel interpolation. However a different expansion formula can be used. For instance, Taylor expansion or Maclaurin series may be used to approximate the sine and cosine functions in order to compute the functions. For example, a Taylor expansion series for a cosine function can be written as follows:

$$Cos x = 1 - \frac{{x}^{2}}{2 !} + \frac{{x}^{4}}{4 !} - \frac{{x}^{6}}{6 !} + \frac{{x}^{8}}{8 !} - \frac{{x}^{10}}{10 !} + … - ∞ < x < ∞ \qquad ( 27 )$$

The above can be put in a form that is more suited for fast computation in the computer. For example, a truncated version of the above can be re-written using Horner's rule and be reorganized as followed:

$$Cos x = 1 - {x}^{2} \cdot ( \frac{1}{2 !} - {x}^{2} \cdot ( \frac{1}{4 !} - {x}^{2} \cdot ( \frac{1}{6 !} - {x}^{2} \cdot ( \frac{1}{8 !} - {x}^{2} \cdot ( \frac{1}{10 !} ) ) ) ) ) \qquad ( 28 )$$

Efficiencies can be reached by pre-computing the factorials in the denominators in a table:

$$t = ( \frac{1}{2 !} , \frac{1}{4 !} , \frac{1}{6 !} , \frac{1}{8 !} , \frac{1}{10 !} ]$$

Therefore equation 28 can be re-written as follows:

$$Cos x = 1 - {x}^{2} \cdot ( {t}_{0} - {x}^{2} \cdot ( {t}_{1} - {x}^{2} \cdot ( {t}_{2} - {x}^{2} \cdot ( {t}_{3} - {x}^{2} \cdot ( {t}_{4} ) ) ) ) ) \qquad ( 29 )$$

It should be noted that the coefficients can be modified in the algorithm, by utilising the built-in recursive nature in the factorials. This will simplify the computer implementation of the computation.

The system implementing the processing discussed in the above may be provided by a computing device. The computing device may be a mobile computing device. Referring to FIG. 5, the system 500 may be implemented in the form of a stationary or portable apparatus 505 which comprises therein a processing module 510 and onboard memory storage 515 as required to store the instructions and the pre-stored values utilised by the algorithm, and system memory 517 to provide run time memory used for the computations. The onboard memory 515 capacity provides a limit on the precisions of the returned trigonometric values and the speed of the calculations. As can be expected, having more pre-stored values will help to reduce the number of computations and thus increase speed. As the skilled person can appreciate, pre-stored values may be entered into the apparatus 505 via an input or input/output interface 535, but instead be downloaded to the computing apparatus 505. The apparatus may be equipped with communication capabilities so that the values can be downloaded, updated or refreshed, or restored (if lost) over a communication network 525. The values may be obtained over the network from a remote data storage which may be a cloud storage 530.

The processing module 510 may be provided be any commercially available processing device, such as a CPU, DSP, a microprocessor, an FPGA, an ASIC, or any other electronic programmable logic device, or a combination thereof. Examples are provided in the description herein. The algorithm implementing the disclosed method may be provided as software modules 520 of computer-executable instructions. The memory 515 may include non-volatile memory or volatile memory, or a combination thereof, including but not limited to ROM, PROM, EEPROM, flash memory, removable memory, RAM, DRAM, SRAM, cache memory, hard drive, solid state drives. The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for estimating a measurement for a geometric dimension of an object, wherein the geometric dimension being measured is at an angle to a reference geometric dimension of the object; comprising a processor, memory storing machine-executable code, and operating system supporting computer processes, the processor being configured to implement the machine-executable code to:
receive data indicative of an input angle between the geometric dimension being measured and the reference geometric dimension;
determine an integral angle and a fractional angle, respectively being an integral portion and a fractional portion of the input angle;
determine trigonometric function values of the fractional angle;
obtain a first rotation matrix representing a first rotation from 0 degrees to the integral angle;
determine a second rotation matrix representing a second rotation by the fractional angle, based on the trigonometric function values of the fractional angle;
determine trigonometric function values of the input angle between the geometric dimensions on the basis of a combination of the first and second rotation matrices;
estimate the measurement based on the trigonometric function values of the input angle and a measurement of the reference geometric dimension.

2. The apparatus of claim 1, wherein determining the first rotation matrix comprises the processor executing read functions to obtain trigonometric function values of the integral angle from a database.

3. The apparatus of claim 2, wherein determining the first rotation matrix comprises determining matrices representing a first partial rotation and a second partial rotation, the first partial rotation covering an angular range, the angular range being determined by a number of angular steps which can fit within the integral angle, wherein each angular step covers a predetermined integer-number of degrees, and wherein the second partial rotation covers a difference between the integral angle and the angular range.

4. The apparatus of claim 2, wherein the trigonometric function values comprise sine and cosine function values.

5. The apparatus of claim 2, wherein the trigonometric function values comprise inverse sine and inverse cosine function values.

6. The apparatus of claim 2, wherein the trigonometric function values comprise sagitta values, wherein values of the first and second rotation matrices are determined from the sagitta values.

7. The apparatus of claim 1, wherein determining trigonometric function values of the fractional angle comprises using a truncated expansion or interpolation formula, wherein the fractional angle in degrees is used as a constant in the truncated expansion or interpolation formula, in operations comprising one or more of: an addition operation, a subtraction operation, a multiplication operation.

8. The apparatus claim 1, wherein the memory has stored therein trigonometric function values for a plurality of whole-degree angles between 0 degrees and at least 90 degrees.

9. The apparatus of claim 8, wherein the trigonometric function values comprise sine and cosine values, or sagitta values, for the plurality of whole-degree angles.

10. The apparatus of claim 8, wherein the plurality of whole-degree angles comprise all angles between 0 degrees and at least 90 degrees.

11. The apparatus of claim 8, wherein the plurality of whole-degree angles comprise every whole-number degree between 0 degree and (N-1) degrees, and every N degrees between 0 degrees and at least 90 degrees, wherein N is an integer greater than or equal to two.
